(19) United States
(12) Patent Application Publication
(10) Pub. No.: US 2023/0056907 A1
(43) Pub. Date: Feb. 23, 2023

(54) FLUIDIC DIES WITH THERMAL SENSORS ON MEMBRANE

(71) Applicant: Hewlett-Packard Development Company, L.P., Spring, TX (US)

(72) Inventors: Eric T. Martin, Corvallis, OR (US); Jeremy Joseph Spencer, Corvallis, OR (US); Donald J. Milligan, Corvallis, OR (US)

(73) Assignee: Hewlett-Packard Development Company, L.P., Spring, TX (US)

(21) Appl. No.: 17/795,374

(22) PCT Filed: Jan. 29, 2020
(86) PCT No.: PCT/US2020/015682

§ 371 Date: Jul. 26, 2022

(51) Int. Cl. B41J 2/045; G01K 3/00

(52) U.S. Cl. CPC B41J 2/04563; G01K 3/005; B41J 2/0458

(57) ABSTRACT

A fluidic die includes a substrate and a thermal sensor arranged on a membrane region of the substrate. The substrate includes a fluid slot formed in a back side of the substrate, while the membrane region is positioned between the fluid slot and a front side of the substrate. The substrate also includes a plurality of fluid feed holes in the membrane region, where each fluid feed hole is in communication with the fluid slot and the front side of the substrate.

### BACKGROUND

In an inkjet printing system, an inkjet printhead prints an image by ejecting drops of a fluid (e.g., printing fluid) by a plurality of fluidic actuators (e.g., fluid ejection elements in ejection chambers to eject droplets via nozzles) onto a print medium, such as a sheet of paper. In other examples, the printing system ejects another fluid, such as a fluid for additive manufacturing (e.g., three-dimensional (3D) printing) onto a surface or build material. The nozzles may be arranged in arrays or columns such that properly sequenced ejection of fluid from the nozzles causes characters and/or images to be printed on the print medium as the printhead and/or print medium move relative to each other. Thermal inkjet (TIJ) printheads eject the fluid drops by passing electrical current through a heating element, which serves as an actuator for the nozzle, to generate heat and vaporize a small portion of the fluid within a firing chamber. The rapidly expanding vapor bubble forces a small fluid drop out of the firing chamber. When the heating element cools, the vapor bubble quickly collapses, drawing more fluid from a reservoir into the firing chamber in preparation for ejecting another drop from the nozzle. Other printheads, such as piezo inkjet (PIJ) printheads, eject fluid drops by providing an electrical current to a piezoelectric element behind the nozzle, which ejects fluid from the nozzle.

Regardless of the type of printhead, during printing, heat from heating elements on the printhead affects the temperature of the printhead, which may also be a fluidic die. Thermal differences over the nozzle array area of the fluidic die influence characteristics of the fluid drops being fired from the nozzles, and can therefore have an adverse impact on overall print quality of the printing system. For example, a higher die temperature results in a higher drop weight and drop velocity, while a lower die temperature results in a lower drop weight and velocity. Thus, variations in temperature across the die can result in variations in drop weight, velocity, and shape.

### BRIEF DESCRIPTION OF THE DRAWINGS

Various examples will be described below referring to the following figures:

FIG. 1 shows a block diagram of a system in accordance with various examples;

FIGS. 2a and 2b show bottom views of a printhead in accordance with various examples;

FIGS. 3a and 3b show cross sectional views of the printheads of FIGS. 2a and 2b in accordance with various examples; and

FIG. 4 shows a flow chart of a method in accordance with various examples.

### DETAILED DESCRIPTION

In the figures, certain features and components disclosed herein may be shown exaggerated in scale or in somewhat schematic form, and some details of certain elements may not be shown in the interest of clarity and conciseness. In some of the figures, in order to improve clarity and conciseness, a component or an aspect of a component may be omitted.

In the following discussion and in the claims, the terms “including” and “comprising” are used in an open-ended fashion, and thus should be interpreted to mean “including, but not limited to . . . .” Also, the term “couple” or “couples” is intended to be broad enough to encompass both indirect and direct connections. Thus, if a first device couples to a second device, that connection may be through a direct connection or through an indirect connection via other devices, components, and connections.

The present disclosure proposes using measurements of the temperature of an inkjet printhead, which may be a fluidic die, and the fluid flowing through fluidic channels of the die to provide greater control of heating elements associated with the die to yield more even temperature distributions across the die. Achieving more even temperature distributions across the die may result in more uniform drop properties, improving overall print quality. Additionally, in the event that a particular thermal profile persists (e.g., thermal variation across the fluidic die), firing energies across the fluidic die may be adjusted to improve the uniformity of fluid drops produced by the fluidic die. Overall printing quality of an inkjet printing system may be improved in response to more even temperature distributions across the fluidic die. And more even temperature distributions of the fluid flowing through the die may result in more uniform drop properties (e.g., size, shape, etc.). Thermal sensors are positioned on the die to sense temperatures of the die. However, in some examples, the thermal sensors are positioned away from the areas of the die through which fluid flows. For example, fluid may flow through a backside slot, firing chamber, and out through a nozzle, while the existence of the backside slot extending through the fluidic die substrate prevents a thermal sensor from being positioned near this area of fluid flow. If the thermal sensors are not in sufficient proximity to fluids, the correlation between thermal sensor measurements and actual fluid temperature may be strained or nonexistent.

The present description refers to thermal sensors, which are devices capable of providing temperature readings, such as in the form of signals, states, or resistance levels. Example thermal sensors may include, but are not limited to, mechanical temperature sensors, electrical temperature sensors, and integrated circuit (IC) sensors. Example sensors may thus include thermal sense resistors (TSRs), thermistors, thermocouples, resistance thermometers, and silicon bandgap temperature sensors, without limitation. For ease of description, the term TSR will be used hereinafter to refer to thermal sensors in a general sense, with the understanding that thermal sensors still may encompass sensors other than TSRs.

Examples of the present disclosure address the TSR proximity issue with a fluidic die that includes a silicon substrate having a membrane region between a back side slot and a front side of the substrate. If the membrane region did not exist, the back side slot would extend from the back side of the substrate through to the front side of the substrate, which prevents positioning a TSR near the slot (e.g., near the flow of fluid through the substrate), since there would be no substrate material upon which a TSR may be situated. By forming the membrane region in the silicon substrate of the fluidic die, a TSR is able to be positioned on the membrane region of the substrate in much closer proximity to the flow of fluid through the fluidic die.

In an example, the disclosed fluidic die includes TSRs arranged on two membrane regions of a substrate of the fluidic die. In some examples, the fluidic die may also include TSRs arranged on the substrate away from the membrane regions in addition to the TSRs arranged on the membrane regions. During operation, a heating system arranged on the die may operate in various modes to maintain a temperature profile across the fluidic die based on inputs from the TSRs arranged on the membrane regions, the TSRs positioned away from the membrane regions, or a combination thereof. Further, while reference may be made to an example thermal inkjet printing system, certain examples of the present disclosure may also apply to other fluidic printing technologies, such as piezo inkjet and others. These and other examples are described more fully below, with reference made to the accompanying figures.

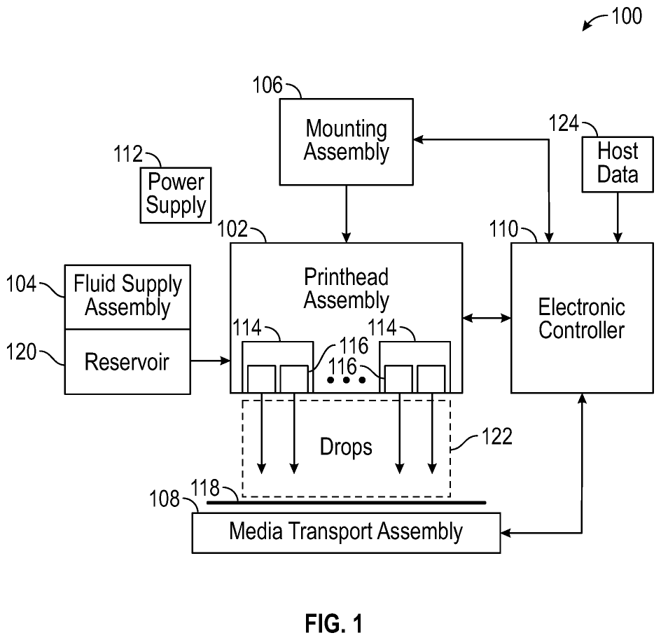

FIG. 1 illustrates a fluid ejection system 100, which in one example is an inkjet printing system suitable for incorporating a fluidic die as part of a fluid ejection assembly 114 as disclosed herein, according to an example of the disclosure. The fluidic die disclosed herein and described in accordance with various examples is not limited to use in an inkjet printing system, but rather may be utilized in any fluid ejection system 100, such as one for use in an additive manufacturing process. Fluid ejection system 100 includes a printhead assembly 102, a fluid supply assembly 104, a mounting assembly 106, a media transport assembly 108, an electronic controller 110, and a power supply 112 that provides power to the various electrical components of fluid ejection system 100. Printhead assembly 102 includes at least two fluid ejection assemblies 114 having a fluidic die that ejects drops of fluid through a plurality of orifices or nozzles 116 toward a print medium 118 so as to print onto print medium 118. In other examples, the printhead assembly 102 may include a single fluid ejection assembly 114, however. The fluid ejection assembly 114 may be a printhead, a fluidic die, or other type of print module through which printing fluid flows. In addition to actuators for ejection of fluid (e.g., thermal resistors or piezo elements), other examples described herein may also include non-ejecting actuators. Example non-ejecting actuators may include microfluidic pumps to move or displace fluid through fluidic channels. In one implementation, a non-ejecting actuator may include a firing element with no associated nozzle. Of course, the scope of this disclosure is not limited to a particular type (e.g., ejecting or non-ejecting) of actuator. Print medium 118 refers to any suitable type of material, such as paper, card stock, transparencies, Mylar, a 3D printing substrate (e.g., a bed of build material), and the like. Nozzles 116 may be arranged in columns or arrays such that properly sequenced ejection of fluid from nozzles 116 causes characters, symbols, and/or other graphics or images to be printed upon print medium 118 as printhead assembly 102 and/or print medium 118 are moved relative to each other.

Fluid supply assembly 104 supplies fluid to printhead assembly 102 and includes a reservoir 120 for storing fluid, such as printing fluid or fluid for additive manufacturing. Fluid flows from reservoir 120 to printhead assembly 102. Fluid supply assembly 104 and printhead assembly 102 can form a one-way fluid delivery system or a recirculating fluid delivery system. In a one-way fluid delivery system, substantially all of the fluid supplied to printhead assembly 102 is consumed during printing. In a recirculating fluid delivery system, however, a portion of the fluid supplied to printhead assembly 102 is consumed during printing. Fluid not consumed during printing is returned to fluid supply assembly 104.

In one example, printhead assembly 102 and fluid supply assembly 104 are housed together in an inkjet cartridge or pen. In another example, fluid supply assembly 104 is separate from printhead assembly 102 and supplies fluid to printhead assembly 102 through an interface connection, such as a supply tube. In either case, reservoir 120 of fluid supply assembly 104 may be removed, replaced, and/or refilled. In one example, where printhead assembly 102 and fluid supply assembly 104 are housed together in an inkjet cartridge, reservoir 120 may include a local reservoir located within the cartridge as well as a larger reservoir located separately from the cartridge. The separate, larger reservoir serves to refill the local reservoir. Accordingly, the separate, larger reservoir and/or the local reservoir may be removed, replaced, and/or refilled.

Mounting assembly 106 positions printhead assembly 102 relative to media transport assembly 108, and media transport assembly 108 positions print medium 118 relative to printhead assembly 102. Thus, a print zone 122 is defined adjacent to nozzles 116 in an area between printhead assembly 102 and print medium 118. In one example, printhead assembly 102 is a scanning type printhead assembly. In a scanning type printhead assembly, mounting assembly 106 includes a carriage for moving printhead assembly 102 relative to media transport assembly 108 to scan print medium 118. In another example, printhead assembly 102 is a non-scanning type printhead assembly. In a non-scanning printhead assembly, mounting assembly 106 fixes printhead assembly 102 at a prescribed position relative to media transport assembly 108. Thus, media transport assembly 108 positions print medium 118 relative to printhead assembly 102.

Electronic controller110 may include a processor, firmware, and other printer electronics for communicating with and controlling printhead assembly 102, mounting assembly 106, and media transport assembly 108. Electronic controller 110 receives host data 124 from a host system, such as a computer, and includes memory for temporarily storing host data 124. Host data 124 is sent to fluid ejection system 100 along an electronic, infrared, optical, or other information transfer path. Host data 124 represents, for example, a document and/or file to be printed. Using host data 124, electronic controller 110 controls printhead assembly 102 to eject fluid drops from nozzles 116. Thus, electronic controller 110 defines a pattern of ejected fluid drops which form characters, symbols, and/or other graphics or images on print medium 118. The pattern of ejected fluid drops is determined by the print job commands and/or command parameters from host data 124.

In one example, printhead assembly 102 includes one fluid ejection assembly 114. In another example, printhead assembly 102 is a wide-array or multi-head printhead assembly having multiple fluid ejection assemblies 114. In one wide-array example, printhead assembly 102 includes a carrier that carries fluid ejection assemblies 114, provides electrical communication between fluid ejection assemblies 114 and electronic controller 110, and provides fluidic communication between fluid ejection assemblies 114 and fluid supply assembly 104. In one example, fluid ejection system 100 is a drop-on demand TIJ printing system wherein fluid ejection assembly 114 is a TIJ printhead, such as described further below.

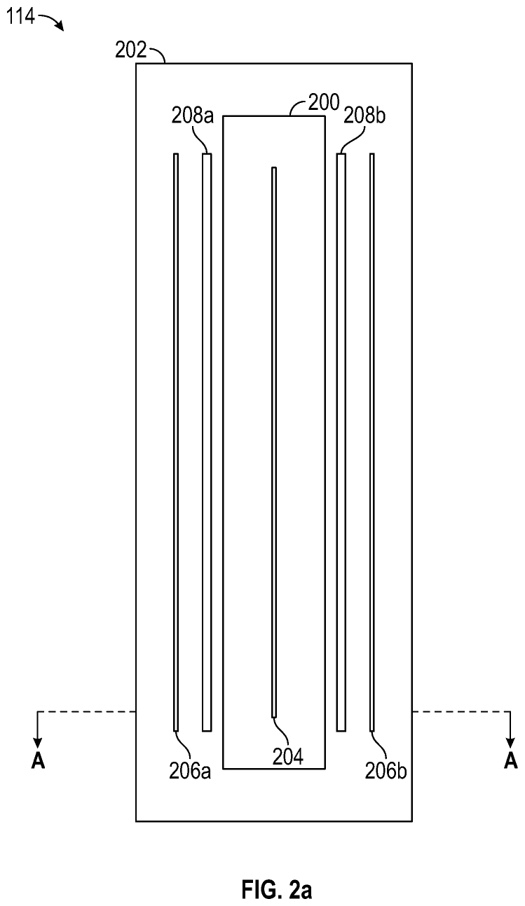

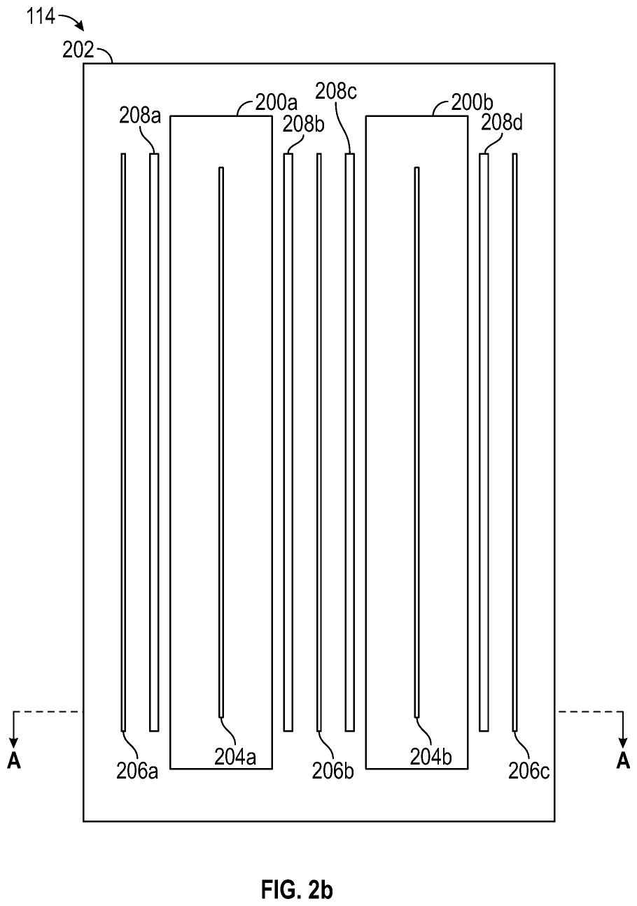

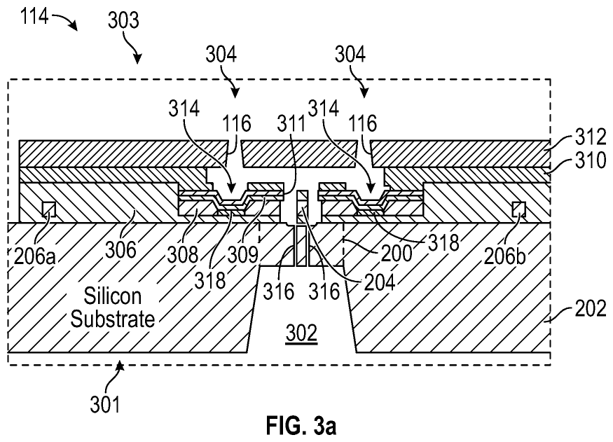

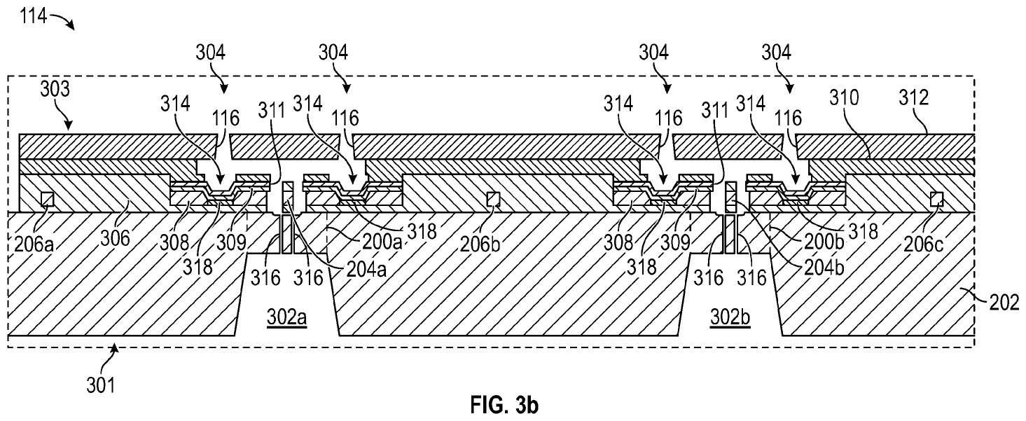

FIG. 2a shows a bottom view of a TIJ printhead as fluid ejection assembly 114 (referred to as a fluidic die 114 for simplicity) having a membrane region 200 formed in a silicon fluidic die substrate 202, according to an example of the disclosure. The membrane region 200 structure is described further below, with respect to FIGS. 3a and 3b. The fluidic die substrate 202 underlies a chamber layer that forms fluid chambers (e.g., for ejection of fluid droplets) and a nozzle layer in which nozzles 116 are formed, as discussed below with respect to FIGS. 3a and 3b. However, for the purpose of illustration, the chamber layer and nozzle layer in FIG. 2a are assumed to be transparent in order to show the underlying fluidic die substrate 202.

In the example of FIG. 2a, the fluidic die substrate 202 includes a single membrane region 200. In some examples, a TSR 204 is arranged on the membrane region 200. In some examples, additional TSRs 206a, 206b are arranged on the fluidic die substrate 202 away from the membrane region 200. For example, the TSR 206a is arranged on the fluidic die substrate 202 on a first side of the membrane region 200 (and its underlying fluid slot, described in further detail below); while the TSR 206b is arranged on the fluidic die substrate 202 on a second side of the membrane region 200.

In some examples, a heating system—including heating elements 208a, 208b—is also arranged on the fluidic die substrate 202. The heating elements 208 are depicted as heaters, or arrays of heaters, arranged in columns along the sides of the membrane region 200. However, in other examples, the heating elements 208 may be arranged in a two-dimensional (2D) array including being arranged on the membrane region 200. The heating system also may include some or all of the TSRs 204, 206a, 206b. Thus, the heating system controls heating elements 208a, 208b based on data received from the TSRs 204, 206a, 206b to maintain a temperature profile (e.g., an approximately even temperature) across the fluidic die substrate 202, which may yield more uniform drop properties.

FIG. 2b shows another example of a bottom view of a TIJ printhead as fluidic die 114 having multiple membrane regions 200a, 200b formed in a silicon fluidic die substrate 202, according to an example of the disclosure. In other examples, there may be more than two membrane regions 200 (and underlying fluid slots, described in further detail below), or one membrane region may extend across multiple underlying fluid slots, also as described further below. The membrane regions 200a, 200b are similar in structure and operation to those described with respect to FIG. 2a, and are described in further detail below with respect to FIGS. 3a and 3b.

In the specific example of FIG. 2b, the fluidic die substrate 202 includes a first membrane region 200a and a second membrane region 200b. In some examples, a first TSR 204a is arranged on the first membrane region 200a and a second TSR 204b is arranged on the second membrane region 200b. In some examples, additional TSRs 206a, 206b, 206c are arranged on the fluidic die substrate 202 away from the membrane regions 200a, 200b. For example, the TSR 206a is arranged on the fluidic die substrate 202 on a side of the first membrane region 200a (and its underlying fluid slot, described in further detail below) away from the second membrane region 200b (and its underlying fluid slot); the TSR 206b is arranged on the fluidic die substrate 202 between the first membrane region 200a and the second membrane region 200b (and their underlying fluid slots); and the TSR 206c is arranged on the fluidic die substrate 202 on a side of the second membrane region 200b (and its underlying fluid slot) away from the first membrane region 200a.

In some examples, a heating system—including heating elements 208a, 208b, 208c, 208d—is also arranged on the fluidic die substrate 202. The heating elements 208 are depicted as heaters, or arrays of heaters, arranged in columns along the sides of the membrane regions 200. However, in other examples, the heating elements 208 may be arranged in a two-dimensional (2D) array including being arranged on the membrane regions 200. The heating system also may include some or all of the TSRs 204a, 204b, 206a, 206b, 206c. Thus, the heating system controls heating elements 208a, 208b, 208c, 208d based on data received from the TSRs 204a, 204b, 206a, 206b, 206c to maintain a temperature profile (e.g., an approximately even temperature) across the fluidic die substrate 202, which may achieve more uniform drop properties.

FIG. 3a shows a cross-sectional view of the fluidic die 114 taken along line A-A of FIG. 2a, according to an example of the disclosure. The fluidic die 114 includes a silicon fluidic die substrate 202. A fluid slot 302 is an elongated slot formed in the fluidic die substrate 202 that extends into the plane of FIG. 3a. In particular, the fluid slot 302 is formed in a back side 301 of the fluidic die substrate 202. The fluid slot 302 is in fluid communication with a fluid supply (not shown), such as a fluid reservoir. The fluidic die 114 includes drop generators 304, which, in one example, include a nozzle 116, a firing chamber 314, and a firing element 318 (which serves as an actuator for the nozzle 116) arranged in the firing chamber 314. Although drop generators 304 are shown as arranged along the sides of the fluid slot 302, in other examples the drop generators 304 may be arranged in a 2D array, including over the membrane region 200 (and thus the fluid slot 302) as well. Nozzles 116 may be arranged in various manners, such as to form arrays extending into the plane of FIG. 3a, for example along the sides of the fluid slot 302, or in a matrix array or pattern.

The firing element 318 may be a thermal resistor formed on an insulating layer 306 (e.g., an oxide layer) on a top surface of the fluidic die substrate 202 and are coupled to a conductive layer 308 applied on top of the insulating layer 306. The conductive layer 308 generally provides a coupling to the firing element 318, and may include various conductive traces. A chamber layer 310 has walls and forms firing chamber 314 that separate the fluidic die substrate 202 from a nozzle layer 312. Nozzles 116 are formed in nozzle layer 312. In some examples, a cavitation plate 311 is provided that may be a conductive film that protects underlying layers (e.g., the firing element 318, the conductive layer 308, and the insulating layer 306) from cavitation forces created when printing fluid bubbles form and collapse in the firing chamber 314. In these and other examples, an additional insulating layer 309 is provided to electrically isolate the firing element 318 from printing fluid in the firing chamber 314 and/or the cavitation plate 311, if present.

During operation, a fluid drop is ejected from a firing chamber 314 through a corresponding nozzle 116 and the firing chamber 314 is then refilled with fluid circulating from fluid slot 302 through a fluid feed hole 316. More specifically, an electric current is passed through a firing element 318 resulting in rapid heating of the element. In response, fluid adjacent to the firing element 318 is superheated and vaporizes, creating a vapor bubble in the corresponding firing chamber 314. The rapidly expanding bubble forces a fluid drop out of the corresponding nozzle 116. When the firing element 318 cools, the vapor bubble quickly collapses, drawing more fluid into the firing chamber 314 in preparation for ejecting another drop from the nozzle 116.

In accordance with an example of this disclosure, a membrane region 200 is positioned between the fluid slot 302 and a front side 303 of the fluidic die substrate 202. The fluid feed holes 316 extend through the membrane region 200 and are in fluidic communication with the fluid slot 302 and the front side 303 of the fluidic die substrate 202. For example, the fluid feed holes 316 permit the flow of fluid from the fluid slot 302 into the firing chamber 314. Unlike the fluid slot 302, which extends into the plane of FIG. 3a, the fluid feed holes 316 and the firing chambers 314 are discrete, rather than continuous, in the direction extending into the plane of FIG. 3a. For example, the fluid feed holes 316 and the firing chamber 314 may not be visible at a slightly deeper or shallower cross section (e.g., if line A-A of FIG. 2a were repositioned in the vertical direction). Thus, the membrane region 200 of the fluidic die substrate 202 permits fluid flow from the fluid slot 302 to the front side 303 of the fluidic die substrate 202, for example, to the firing chamber 314 via the fluid feed holes 316, but also provides a portion of fluidic die substrate 202 material upon which a TSR 204 may be positioned proximate the flow of fluid through the fluidic die 114. In an example, the TSR 204 is aligned with the fluid slot 302 (e.g., in the vertical direction in FIG. 3a). Since the firing chamber 314 is also discrete in the direction extending into the plane of FIG. 3a, the TSR 204 may be coupled to or formed in the conductive layer 308 (e.g., although the TSR 204 appears isolated from the conductive layer 308 in FIG. 3a, the TSR 204 is not isolated from the conductive layer 308 at all cross sections).

In the absence of the membrane region 200 of this disclosure, the fluid slot 302 would extend through the fluidic die substrate 202 (and, in some examples, the insulating layer 306 and the conductive layer 308). Such a fluid slot extending through the fluidic die substrate 202 prevents a TSR from being positioned near the flow of fluid through the fluidic die substrate 202. For example, with the fluid slot extending through the fluidic die substrate 202, there is no fluidic die substrate 202 material aligned with the fluid slot, and thus it is not possible to locate the TSR 204 as shown, aligned with the fluid slot 302 and proximate to the flow of fluid through the fluid slot 302, the fluid feed holes 316, the firing chambers 314, and out through the nozzles 116. While it would still be possible to locate the TSRs 206a, 206b as shown if the fluid slot 302 extends through the fluidic die substrate 202, the TSRs 206a, 206b are positioned away from the flow of fluid through the fluid slot 302, the fluid feed holes 316, the firing chambers 314, and out through the nozzles 116. As a result, the TSRs 206a, 206b are relatively distant from the fluid flowing through the fluidic die 114, and thus data from those TSRs 206a, 206b may be less correlated to actual fluid temperature.

Thus, in accordance with examples of this disclosure, the membrane region 200 facilitates the location of the TSR 204 with greater proximity to the flow of fluid through the fluid slot 302, the fluid feed holes 316, the firing chambers 314, and out through the nozzles 116. As a result, temperature data generated by the TSR 204 is more closely correlated to the temperature of the fluid flowing through the fluidic die 114. In this example, the TSRs 204, 206a, 206b are formed in the conductive layer 308 (e.g., from a conductive thin film), which also couples to the firing elements 318. However, in other examples, the TSRs 204, 206a, 206b may be part of a unique conductive layer relative to the firing elements 318.

FIG. 3b shows a cross-sectional view of the fluidic die 114 taken along line A-A of FIG. 2b, according to an example of the disclosure. The fluidic die 114 of FIG. 3b is similar to that shown in 3a, but includes first and second fluid slots 302a, 302b instead of a single fluid slot 302. The fluid slots 302a, 302b are similar in structure and operation to those described above with respect to FIG. 3a. Additionally, the drop generators 304 (including nozzles 116, firing chamber 314, and firing element 318), insulating layer 306, conductive layer 308, insulating layer 309, chamber layer 310, cavitation plate 311 (if included), nozzle layer 312, and fluid feed holes 316 are similar in structure and operation to those described above with respect to FIG. 3a.

In accordance with an example of this disclosure, a different one of the membrane regions 200a, 200b is positioned between each of the fluid slots 302a, 302b, respectively, and a front side 303 of the fluidic die substrate 202. The fluid feed holes 316 extend through the membrane region 200a, 200b and are in fluidic communication with one of the fluid slots 302a, 302b and the front side 303 of the fluidic die substrate 202. For example, the fluid feed holes 316 permit the flow of fluid from the fluid slots 302a, 302b into the firing chambers 314. As above, the fluid feed holes 316 and the firing chambers 314 are discrete, rather than continuous, in the direction extending into the plane of FIG. 3b. Thus, the membrane regions 200a, 200b of the fluidic die substrate 202 permit fluid flow from the respective underlying fluid slot 302a, 302b to the front side 303 of the substrate 202, for example to the firing chamber 314 via the fluid feed holes 316. The membrane regions 200a, 200b also provide a portion of fluidic die substrate 202 material upon which TSRs 204a, 204b may be positioned, proximate the flow of fluid through the fluidic die 114. In an example, the TSRs 204a, 204b are aligned with the respective fluid slot 302a, 302b (e.g., in the vertical direction in FIG. 3b). Since the firing chambers 314 are also discrete in the direction extending into the plane of FIG. 3b, the TSRs 204a, 204b may be coupled to or formed in the conductive layer 308 (e.g., although the TSRs 204a, 204b appear isolated from the conductive layer 308 in FIG. 3b, the TSRs 204a, 204b are not isolated from the conductive layer 308 at all cross sections).

In other examples, the fluidic die 114 may include more than two membrane regions 200a, 200b (and associated underlying fluid slots 302), or one membrane region may extend across multiple underlying fluid slots. For example, a single membrane region 200 including fluid feed holes 316 may exist to provide fluid communication from both of the fluid slots 302a, 302b to the front side 303 of the fluidic die substrate 202. In another example, a membrane region 200 may be positioned between the front side 303 of the fluidic die substrate 202 and a backside channel having a backside inlet and a backside outlet for recirculation of printing fluid through the fluidic die 114. Regardless of the particular configuration of backside slots 302 and/or channels, the membrane regions 200 described herein permit the placement of TSRs 204 thereon, which locates the TSRs 204 more proximate to the flow of fluid through the fluidic die 114 than would be possible in arrangements where the fluid slot(s) extend through the fluidic die substrate 202.

As above, in the absence of the membrane regions 200a, 200b of this disclosure, fluid slots extend through the fluidic die substrate 202 (and, in some examples, the insulating layer 306 and the conductive layer 308). This prevents a TSR from being positioned near the flow of fluid through the fluidic die substrate 202. As in FIG. 3a, it would still be possible to locate the TSRs 206a, 206b, 206c as shown if the fluid slot extends through the fluidic die substrate 202. However, the TSRs 206a, 206b, 206c are relatively distant from the fluid flowing through the fluidic die 114, and thus data from those TSRs 206a, 206b, 206c may be less correlated to actual fluid temperature.

Thus, in accordance with examples of this disclosure, the membrane regions 200a, 200b facilitate the location of the TSRs 204a, 204b with greater proximity to the flow of fluid through the fluid slot 302a, 302b, the fluid feed holes 316, the firing chambers 314, and out through the nozzles 116. As a result, temperature data generated by the TSRs 204a, 204b is more closely correlated to the temperature of the fluid flowing through the fluidic die 114. In this example, the TSRs 204a, 204b, 206a, 206b, 206c are formed in the conductive layer 308 (e.g., from a conductive thin film), which also couples to the firing elements 318. However, in other examples, the TSRs 204a, 204b, 206a, 206b, 206c may be part of a unique conductive layer relative to the firing elements 318.

While FIGS. 2a, 2b, 3a, and 3b have been described with respect to a fluidic die 114 containing one or two back side fluid slots 302, having an associated membrane region 200, the examples of this disclosure are not limited to this particular numerical arrangement. For example, other examples may include a fluidic die having a single fluid slot and associated membrane region with a TSR arranged thereon (as shown in FIGS. 2a and 3a), or multiple fluid slots, each having an associated membrane region, or sharing a membrane region, with a TSR arranged thereon. Further, in some examples the fluid slot(s) are replaced with a backside fluid channel to facilitate recirculation of fluid through the fluidic die 114. Still further, the number and position of the TSRs 204, 206 on the fluidic die substrate 202 may differ from that shown, and this disclosure is not limited in scope to the particular arrangement of TSRs 204, 206 described above with respect to FIGS. 2a, 2b, 3a, and 3b.

Referring back to FIGS. 2a and 2b, and as explained above, a heating system includes the heating elements 208 in addition to some or all of the TSRs 204, 206. In other examples, thermal resistor firing elements 318 (discussed above with respect to FIGS. 3a and 3b) can be engaged to function as heating elements of the heating system. In such examples, firing elements 318 are driven at a sub-turn-on-energy level such that they do not eject drops of ink, but still generate heat to warm the fluidic die 114. The heating system may also include a controller (e.g. a processing device), which is not shown for simplicity, that is coupled to some or all of the TSRs 204, 206 and the heating elements 208. In one example, the electronic controller 110 described above also functions as the heating system controller; while in other examples, the heating system uses a separate controller.

Regardless of the form of the heating system controller, the heating system controller is configured to receive temperature data from some or all of the TSRs 204, 206 and, based on the received temperature data, control the heating elements 208, for example by varying the power (or selectively applying power) provided to the heating elements 208, and thus the heat generated by the heating elements 208. As explained above, in some examples, the heating system maintains a particular temperature profile across a surface of the fluidic die 114 in order to maintain a certain level of print quality, for example by providing more uniform drop properties.

In one example, referring to the first membrane region 200a (and its underlying fluid slot 302a), the heating system is configured to regulate the temperature of the fluidic die 114 by controlling the heating element on a first side of the membrane region 200a (e.g., heating element 208a) in response to temperature data received from the TSR 206a on the first side of the membrane region 200a. Continuing this example, the heating system is configured to regulate the temperature of the fluidic die 114 by controlling the heating element on a second side of the membrane region 200a (e.g., heating element 208b) in response to temperature data received from the TSR 206b on the second side of the membrane region 200a. For example, if temperature data from the TSR 206a indicates a temperature below a threshold, then heating power to the heating element 208a may be increased (or the heating element 208a activated); conversely, if temperature data from the TSR 206a indicates a temperature above a threshold, then heating power to the heating element 208a may be decreased (or the heating element 208a deactivated). The heating system may control the heating element 208b similarly, based on the temperature data from the TSR 206b. Similarly, the heating system may control the heating element 208c based on temperature data from the TSR 206b (e.g., on the same side of the membrane region 200b) and may control the heating element 208d based on temperature data from the TSR 206c (e.g., on the same side of the membrane region 200b).

In another example, referring to the first membrane region 200a (and its underlying fluid slot 302a), the heating system is configured to regulate the temperature of the fluidic die 114 by controlling the heating element on the first and second sides of the membrane region 200a (e.g., heating elements 208a, 208b) in response to temperature data received from the TSR 204a arranged on the membrane region 200a. For example, if temperature data from the TSR 204a indicates a temperature below a threshold, then heating power to the heating elements 208a, 208b may be increased (or the heating elements 208a, 208b activated); conversely, if temperature data from the TSR 204a indicates a temperature above a threshold, then heating power to the heating elements 208a, 208b may be decreased (or the heating elements 208a, 208b deactivated). Similarly, the heating system may control the heating elements 208c, 208d based on temperature data from the TSR 204b (e.g., arranged on the membrane region 200b).

In yet another example, referring to the first membrane region 200a (and its underlying fluid slot 302a), the heating system is configured to regulate the temperature of the fluidic die 114 by controlling the heating element on the first side of the membrane region 200a (e.g., heating element 208a) in response to temperature data received from the TSR 206a on the first side of the membrane region 200a and temperature data received from the TSR 204a arranged on the membrane region 200a. Continuing this example, the heating system is configured to regulate the temperature of the fluidic die 114 by controlling the heating element on the second side of the membrane region 200a (e.g., heating element 208b) in response to temperature data received from the TSR 206b on the second side of the membrane region 200a and temperature data received from the TSR 204a arranged on the membrane region 200a. For example, if temperature data from both the TSR 206a and the TSR 204a indicates a temperature below a threshold, then heating power to the heating element 208a may be increased (or the heating element 208a activated); conversely, if temperature data from both the TSR 206a and the TSR 204a indicates a temperature above a threshold, then heating power to the heating element 208a may be decreased (or the heating element 208a deactivated). The heating system may control the heating element 208b similarly, based on the temperature data from the TSR 206b and the TSR 204a. Similarly, the heating system may control the heating element 208c based on temperature data from the TSR 206b (e.g., on the same side of the membrane region 200b) and the TSR 204b (e.g., arranged on the membrane region 200b); and may control the heating element 208d based on temperature data from the TSR 206c (e.g., on the same side of the membrane region 200b) and the TSR 204b (e.g., arranged on the membrane region 200b).

In still another example, referring to the first membrane region 200a (and its underlying fluid slot 302a), the heating system is configured to regulate the temperature of the fluidic die 114 by controlling the heating element on the first side of the membrane region 200a (e.g., heating element 208a) in response to temperature data received from the TSR 206a on the first side of the membrane region 200a or temperature data received from the TSR 204a arranged on the membrane region 200a. Continuing this example, the heating system is configured to regulate the temperature of the fluidic die 114 by controlling the heating element on the second side of the membrane region 200a (e.g., heating element 208b) in response to temperature data received from the TSR 206b on the second side of the membrane region 200a or temperature data received from the TSR 204a arranged on the membrane region 200a. For example, if temperature data from either the TSR 206a or the TSR 204a indicates a temperature below a threshold, then heating power to the heating element 208a may be increased (or the heating element 208a activated); conversely, if temperature data from either the TSR 206a or the TSR 204a indicates a temperature above a threshold, then heating power to the heating element 208a may be decreased (or the heating element 208a deactivated). The heating system may control the heating element 208b similarly, based on the temperature data from either the TSR 206b or the TSR 204a. Similarly, the heating system may control the heating element 208c based on temperature data from either the TSR 206b (e.g., on the same side of the membrane region 200b) or the TSR 204b (e.g., arranged on the membrane region 200b); and may control the heating element 208d based on temperature data from either the TSR 206c (e.g., on the same side of the membrane region 200b) or the TSR 204b (e.g., arranged on the membrane region 200b).

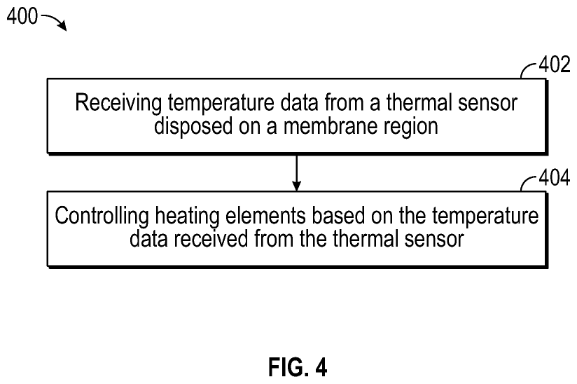

Turning to FIG. 4, a method 400 is shown in accordance with various examples. The method 400 is generally directed to the operation of the heating system, explained above. In this example, the method 400 begins in block 402 with receiving temperature data from a TSR 204 arranged on a membrane region, such as the membrane region 200. As explained above, the membrane region 200 is between the slot 302 formed in the back side 301 of the fluidic die substrate 202 and the front side 303 of the substrate 202.

The method 400 continues in block 404 with controlling heating elements (e.g., 208a, 208b) based on the temperature data received from the TSR 204. As explained above, the temperature of the heating elements 208 is controlled to maintain a temperature profile across a surface of the fluidic die 114 by selectively applying heat to different areas of the fluidic die 114, which may result in more uniform drop properties as well.

As used herein, including in the claims, the word “or” is used in an inclusive manner. For example, “A or B” means any of the following: “A” alone, “B” alone, or both “A” and “B.”

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. A fluidic die, comprising:
a substrate, comprising:
a fluid slot formed in a back side of the substrate;
a membrane region positioned between the fluid slot and a front side of the substrate; and
a plurality of fluid feed holes in the membrane region, each fluid feed hole in communication with the fluid slot and the front side of the substrate; and
a thermal sensor arranged on the membrane region of the substrate.

2. The fluidic die of claim 1, wherein the thermal sensor comprises a thermal sense resistor.

3. The fluidic die of claim 1, comprising a thermal sensor arranged on the substrate physically separate from the membrane region.

4. The fluidic die of claim 1, comprising:
a thermal sensor arranged on the substrate on a first side of the fluid slot; and
a thermal sensor arranged on the substrate on a second side of the fluid slot.

5. The fluidic die of claim 1, comprising:
a conductive layer arranged on the front side of the substrate,
wherein the thermal sensor is formed in the conductive layer.

6. The fluidic die of claim 1, wherein the fluid slot is a first fluid slot and the substrate comprises:
a second fluid slot formed in the back side of the substrate;
a second membrane region positioned between the second fluid slot and the front side of the substrate;
a plurality of fluid feed holes in the second membrane region, each fluid feed hole in communication with the second fluid slot and the front side of the substrate;
wherein the fluidic die comprises:
a thermal sensor arranged on the second membrane region of the substrate;
a thermal sensor arranged on the substrate on a side of the first fluid slot away from the second fluid slot;
a thermal sensor arranged on the substrate between the first and second fluid slots; and
a thermal sensor arranged on the substrate on a side of the second fluid slot away from the first fluid slot.

7. A thermal inkjet printing system, comprising:
a fluidic die, comprising:
a fluid slot formed in a back side of a substrate;
a membrane region between the fluid slot and a front side of the substrate; and
an actuator in fluid communication with the fluid slot via a fluid feed hole in the membrane region; and
a heating system arranged on the die to maintain a temperature profile across a surface of the die through selective application of heat to different areas of the die in response to temperature data sensed at different areas of the die, the heating system comprising a plurality of heating elements and a plurality of thermal sensors including a thermal sensor arranged on the membrane region.

8. The thermal inkjet printing system of claim 7, wherein the heating system comprises:
a thermal sensor on a first side of the fluid slot and a thermal sensor on a second side of the fluid slot; and
a heating element on the first side of the fluid slot and a heating element on the second side of the fluid slot.

9. The thermal inkjet printing system of claim 8, wherein a controller of the heating system is to:
regulate the heating element on the first side of the fluid slot in response to temperature data received from the thermal sensor on the first side of the fluid slot; and
regulate the heating element on the second side of the fluid slot in response to temperature data received from the thermal sensor on the second side of the fluid slot.

10. The thermal inkjet printing system of claim 8, wherein a controller of the heating system is to:
regulate the heating elements on the first and second sides of the fluid slot in response to temperature data received from the thermal sensor arranged on the membrane region.

11. The thermal inkjet printing system of claim 8, wherein a controller of the heating system is to:
activate the heating element on the first side of the fluid slot in response to temperature data received from the thermal sensor on the first side of the fluid slot and the thermal sensor arranged on the membrane region being below a temperature threshold; and
activate the heating element on the second side of the fluid slot in response to temperature data received from the thermal sensor on the second side of the fluid slot and the thermal sensor arranged on the membrane region being below the temperature threshold.

12. The thermal inkjet printing system of claim 8, wherein the heating system is to:
activate the heating element on the first side of the fluid slot in response to temperature data received from the thermal sensor on the first side of the fluid slot or the thermal sensor arranged on the membrane region being below a temperature threshold; and
activate the heating element on the second side of the fluid slot in response to temperature data received from the thermal sensor on the second side of the fluid slot or the thermal sensor arranged on the membrane region being below the temperature threshold.

13. A method, comprising:
receiving temperature data from a thermal sensor arranged on a membrane region, the membrane region between a slot formed in a back side of a fluidic die substrate and a front side of the fluidic die substrate; and
controlling heating elements arranged on the fluidic die substrate based on the temperature data to maintain a temperature profile across a surface of the fluidic die substrate by selectively applying heat to different areas of the substrate.

14. The method of claim 13, wherein:
receiving temperature data comprises receiving temperature data from a thermal sensor on a first side of the fluid slot and a thermal sensor on a second side of the fluid slot; and
the heating elements comprise a heating element on the first side of the fluid slot and a heating element on the second side of the fluid slot.

15. The method of claim 14, comprising:
regulating the heating elements on the first and second sides of the fluid slot in response to the temperature data received from the thermal sensor arranged on the membrane region.
